(19) United States
(12) Patent Application Publication
(10) Pub. No.: US 2010/0186191 A1
(43) Pub. Date: Jul. 29, 2010

(54) REDUCTION DEVICE FOR LARGE DIAMETER BAG PORTS

(75) Inventors: Christian Mares, Laudun (FR); Pierre Riba, Sauveterre (FR)

Correspondence Address: Nixon Peabody LLP, P.O. Box 60610, Palo Alto, CA, 94306, US

(73) Assignee: AREVA NC, Paris (FR)

(21) Appl. No.: 12/676,140

(22) PCT Filed: Sep. 9, 2008
(86) PCT No.: PCT/EP2008/061921

§ 371 Date: Mar. 2, 2010

(30) Foreign Application Priority Data
Sep. 11, 2007 (FR) 07/57490

(51) Int. Cl. B25J 19/00; B25J 21/02

(52) U.S. Cl. 16/2.1

(57) ABSTRACT

Device for large diameter bag port comprises a diameter reduction spacer with a first circular orifice of the diameter equal to the diameter of the port bag. This first orifice is facing towards the bag port. This device comprises also a second orifice facing towards the outside of the containment in the direction opposite to the first orifice, this second orifice being elongated in shape, particularly ovoid.

CROSS REFERENCE TO RELATED APPLICATIONS or PRIORITY CLAIM

This application is a national phase of International Application No. PCT/EP2008/061921, entitled, “DEVICE FOR REDUCING THE DIAMETER OF BAG PORTS”, which was filed on Sep. 9, 2008, and which claims priority of French Patent Application No. 07 57490, filed Sep. 11, 2007.

### DESCRIPTION

### Technical Domain

The invention relates to a device for reducing the diameter of a glove port fitted on a containment such as a glove box.

Glove boxes are usually ventilated with nitrogen during normal operation by a specific circuit common to all glove boxes called <<containment ventilation>>, this entire circuit being at a negative pressure relative to the rooms in which the glove boxes are installed.

Orifices called bag ports with a diameter varying from 500 to 800 mm are used for some major work, requiring in particular the entry/exit of large equipment. The negative pressure in glove boxes during these operations must be brought to about −100 Pa instead of −350 Pa during normal operation. The purpose of this reduction in the negative pressure is so that vinyl sleeves used for equipment entry/exit can be manipulated. When the negative pressure is as high as 350 Pa, the risk of the sleeve being drawn into the glove box is too high. The accepted limit for entry/exit operations through bag port is limited to an area corresponding to a maximum diameter of 400 mm for a specialised contractor and 330 mm for non-specialist workers, when the negative pressure during normal operation is −350 Pa.

For safety reasons, the entire <<containment ventilation>> network cannot be brought to −100 Pa. Consequently, the glove box concerned needs to be isolated in mechanical means (contact) from the containment ventilation network assembly and therefore to change to air ventilation. In this case, air enters the glove boxes through valves that draw air in from the process room.

The mechanical isolation (contact) of the glove box concerned takes time, human resources and creates dosimetry for the workers.

Contact locations are usually fitted with sensors that position containers that transit through these contact zones during normal operation. They are usually interface zones between two glove boxes. Mechanical isolation of the glove box causes the loss of settings in sensors at the interface and the glove box at the contact point.

The purpose of this invention is a device that avoids the changeover to air ventilation to introduce large equipment into a glove box.

Documents EP 0 549 450 and WO 96/11092 describe prior art.

According to the invention, these objectives are achieved by the fact that the device comprises a diameter reduction spacer with a first circular orifice of the diameter equal to the diameter of the bag port, this first orifice facing towards the bag port and a second orifice facing towards the outside of the containment in the direction opposite to the first orifice, the second orifice being elongated in shape and particularly ovoid.

This elongated shape, for example ovoid, allows the passage of equipment for which one of the dimensions is greater than its small axis provided that it is less than its large axis.

In one particular embodiment, the first orifice is connected to the containment bag port through a vinyl sleeve with a sealed connection.

In another particular embodiment, the second orifice is closed by a vinyl bag. For example, the diameter of the first orifice is between 500 and 800 mm and the large axis of the second orifice measures not more than 400 mm.

Other characteristics and advantages of the invention will become clearer after reading the following description of example embodiments given for illustration with reference to the appended figures. On these figures:

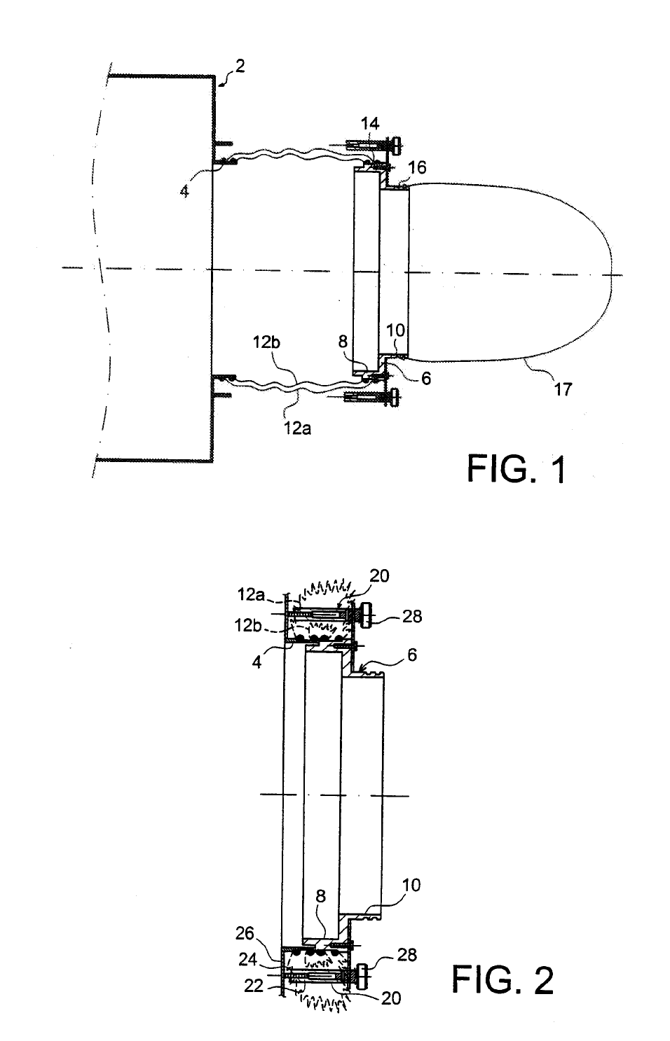

FIG. 1 is a diagrammatic overview of a diameter reduction device for a bag port according to this invention;

FIG. 2 is a variant of the device in FIG. 1;

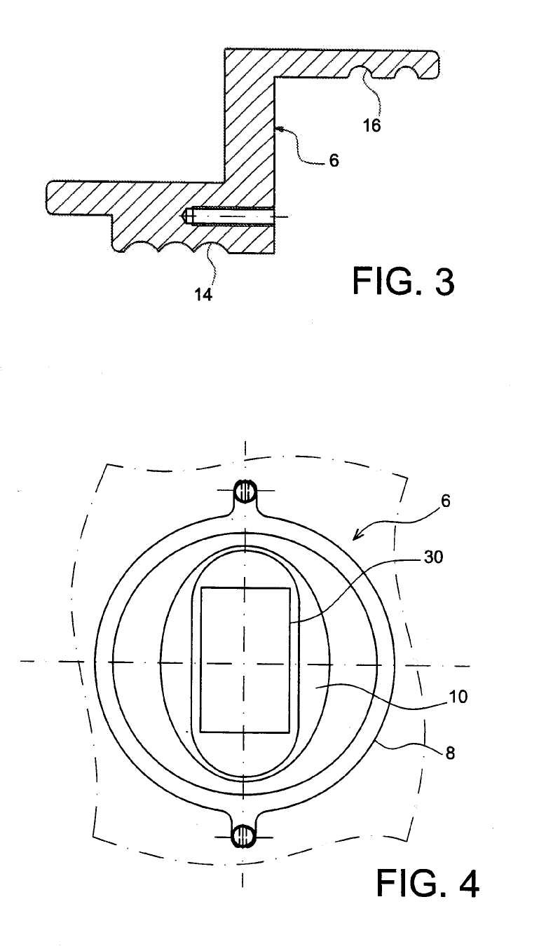

FIG. 3 is an enlarged view of an important part of the diameter reduction spacer;

FIG. 4 is a front view of the diameter reduction spacer.

On FIG. 1, general reference 2 denotes a glove box. This glove box is equipped with a bag port 4 with a diameter of between 500 and 800 mm. Reference 6 denotes a diameter reduction spacer. This diameter reduction spacer comprises a first circular orifice 8 with a diameter approximately equal to the diameter of the bag port 4. The diameter 8 faces the bag port 4. At its opposite end, the diameter reduction spacer 6 comprises a second orifice 10. This second orifice is ovoid in shape. It has a small axis and a large axis, the length of the large axis being less than the diameter of the large orifice 8. For example, the length of the large axis of the ovoid orifice 10 is 400 mm. A large diameter vinyl sleeve 12 is installed at a first end on the bag port 4 and at a second end on the outside periphery of the large diameter orifice 8. The vinyl sleeve is provided with a ring at each end. The ring diameter is adapted to the diameter of the sleeve orifices. The large diameter orifice is provided with a plurality of grooves 14 on the outside that retain the vinyl sleeve. The vinyl sleeve is fitted with a retaining ring at each end. The ring diameter is adapted to the diameter of the sleeve orifices.

The vinyl sleeve may be fixed in two positions. The first position denoted by reference 12a is used for reduction manipulations (return to the as-made configuration), or the tunnel sleeve can be put into the second position denoted by reference 12b.

In this second position, the tunnel sleeve is in its normal position for use of the diameter reduction spacer.

The second orifice 10 is provided with grooves 16 on its outside periphery that retain a closing bag 17, for example made of vinyl. The reduction in section avoids the potential phenomenon by which large diameter vinyl sleeves can be sucked in.

FIG. 2 shows the device in FIG. 1 in a different configuration. The diameter reduction spacer 6 is connected directly to the bag port 4. Attachment devices 20 hold the diameter reduction spacer 6 on the bag port 4. In the example embodiment shown, these means are composed of a tube 22 threaded on the inside that screws onto a screw 24 fixed to the wall 26 on which the bag port 4 is fitted. A knurled knob 28 assures that the screw is kept tight.

FIG. 3 shows a larger scale detail of the inside part of the diameter reduction spacer 6. This figure shows grooves 14 used to attach the vinyl sleeve and grooves 16 used to attach the vinyl bag 17.

FIG. 4 shows a front view of the diameter reduction spacer 6. This figure shows the large diameter orifice 8 and the small diameter orifice 10. Due to its elongated shape, the second orifice 10 is used to transfer parts 30 with a dimension larger than parts that could pass through a conventional type of bag port.

For example, actuator with its support, a press foot, a working grinding wheel or waste can be brought into or taken out of the containment. These are fairly large items of equipment. They cannot be passed through a 300 mm diameter bag port because one of their dimensions is larger than this, but they can be introduced through a bag port of this specific shape with an equivalent area that remains below the area of a 330 mm diameter circular bag port.

1. Device for reducing the diameter of a bag port, fitted on a containment such as a glove box, characterised in that it comprises a diameter reduction spacer with a first circular orifice of the diameter equal to the diameter of the bag port, this first orifice facing towards the bag port, and the second orifice facing towards the outside of the containment in the direction opposite to the first orifice, this second orifice being elongated in shape and particularly ovoid.

2. Device according to claim 1, characterised in that the first orifice is connected to the containment bag port through a vinyl sleeve with a sealed connection.

3. Device according to claim 1, characterised in that the second orifice is closed by a vinyl bag.

4. Device according to claim 1, characterised in that the diameter of the first orifice is between 500 and 800 mm.

5. Device according to claim 1, characterised in that the second orifice has a large axis that measures less than 400 mm.
